(19) United States
(12) Patent Application Publication
(10) Pub. No.: US 2022/0126752 A1
(43) Pub. Date: Apr. 28, 2022

(54) REAR-VIEW MIRROR WITH DISPLAY FUNCTION

(71) Applicant: Unimicron Technology Corp., Taoyuan City (TW)

(72) Inventors: Tzyy-Jang Tseng, Taoyuan City (TW); Shih-Yao Lin, Hsin-chu County (TW); Ansheng Lee, Hsin-chu County (TW); Meng-Chia Chan, Hsin-chu County (TW); Ming-Yuan Hsu, Hsin-chu County (TW); Chengming Weng, New Taipei City (TW)

(73) Assignee: Unimicron Technology Corp., Taoyuan City (TW)

(21) Appl. No.: 17/123,120

(22) Filed: Dec. 16, 2020

(30) Foreign Application Priority Data
Oct. 23, 2020 (TW) 109136850

(51) Int. Cl. B60R 1/12; B60R 1/08

(52) U.S. Cl. CPC B60R 1/1207; B60R 2001/1215; B60R 1/08

(57) ABSTRACT

A rear-view mirror with a display function includes a rear-view mirror body and a display structure layer. The display structure layer is disposed on one side of the rear-view mirror body and includes a plurality of light-emitting diodes and a driving circuit layer. The light-emitting diodes are located between the rear-view mirror body and the driving circuit layer. The light-emitting diodes are electrically connected to the driving circuit layer.

### CROSS-REFERENCE TO RELATED APPLICATION

This application claims the priority benefit of Taiwan application serial no. 109136850, filed on Oct. 23, 2020. The entirety of the above-mentioned patent application is hereby incorporated by reference herein and made a part of this specification.

### BACKGROUND

### Technical Field

The disclosure relates to a rear-view mirror, and particularly relates to a rear-view mirror with a display function.

### Description of Related Art

Generally, people have a limited field of vision when driving a vehicle. Vehicle drivers may only determine surrounding and rear vehicles when driving on the road through a left side and a right side rear-view mirrors and an interior rear-view mirror. Therefore, the driver's line of sight has blind spots, i.e., the so-called “blind zones”. If motorcycles or vehicles enter the rear blind zones on both sides, the driver cannot detect the presence of other vehicles through the left side and the right side rear-view mirrors and the interior rear-view mirror. Even if a blind spot warning system is installed, such a device only flashes light at edges of the left side and the right side rear-view mirrors or sends audible warnings, and the driver still cannot actually see the surrounding vehicles.

In addition, the existing digital LCD display installed on the interior rear-view mirror is subject to a backlight brightness adjustment design (a turn-on/off function), and thus the displayed images are easily unclear due to the serious light reflection of the external environment during daytime driving; on the contrary, when driving at night, the displayed images are overly bright, thus causing fatigue and dazzling when the driver watches the displayed images for a long time and casting doubts on driving safety of the driver. In order to solve the above-mentioned issues, various brightness enhancement films are currently applied to mitigate the defects, but the manufacturing cost of the rear-view mirror is also increased.

### SUMMARY

The disclosure is directed to a rear-view mirror with a display function, which improves driving safety of a driver.

The disclosure provides a rear-view mirror with a display function including a rear-view mirror body and a display structure layer. The display structure layer is disposed on one side of the rear-view mirror body and includes a plurality of light-emitting diodes and a driving circuit layer. The light-emitting diodes are located between the rear-view mirror body and the driving circuit layer. The light-emitting diodes are electrically connected to the driving circuit layer.

In an embodiment of the disclosure, the rear-view mirror body includes a substrate, a transparent electrode layer, a reflective electrode layer, a sealant, and an electrochromic material. The transparent electrode layer is disposed on the substrate. The reflective electrode layer is disposed on one side of the transparent electrode layer. The sealant is disposed between the transparent electrode layer and the reflective electrode layer. The sealant, the transparent electrode layer, and the reflective electrode layer define an accommodating space. The electrochromic material fills the accommodating space.

In an embodiment of the disclosure, an incident beam enters from the outside through a viewing surface of the substrate, and the incident beam is reflected by the reflective electrode layer and exits from the viewing surface of the substrate. A reflectivity of the rear-view mirror body to the incident beam is greater than 40%, and a transmittance of the rear-view mirror to an image beam is greater than 15%.

In an embodiment of the disclosure, the display structure layer further includes a substrate and a first planarization layer. The driving circuit layer is disposed on the substrate and located between the light-emitting diodes and the substrate. The first planarization layer is disposed on the light-emitting diodes, and the light-emitting diodes are located between the first planarization layer and the driving circuit layer.

In an embodiment of the disclosure, the display structure layer further includes a color conversion layer and a second planarization layer. The color conversion layer is disposed on the first planarization layer. The second planarization layer is disposed on the color conversion layer and located between the rear-view mirror body and the color conversion layer.

In an embodiment of the disclosure, the color conversion layer includes a phosphor layer or a quantum dot layer.

In an embodiment of the disclosure, the light-emitting diodes include a plurality of monochromatic diodes, such as a plurality of blue micro light-emitting diodes or a plurality of white micro light-emitting diodes.

In an embodiment of the disclosure, the driving circuit layer includes an active device array circuit or a redistribution circuit layer.

In an embodiment of the disclosure, the display structure layer further includes a second planarization layer located between the driving circuit layer and the light-emitting diodes.

In an embodiment of the disclosure, the light-emitting diodes include at least one red light-emitting diode, at least one green light-emitting diode, and at least one blue light-emitting diode.

In an embodiment of the disclosure, the driving circuit layer includes a redistribution circuit layer.

In an embodiment of the disclosure, the display structure layer further includes a passivation layer, a substrate, and a planarization layer. The driving circuit layer is disposed on the passivation layer and located between the light-emitting diodes and the passivation layer. The substrate is disposed on the light-emitting diodes and is located between the rear-view mirror body and the passivation layer. The planarization layer is disposed between the passivation layer and the substrate.

In an embodiment of the disclosure, the display structure layer further includes a color conversion layer disposed on the planarization layer and located between the substrate and the planarization layer. The planarization layer is located between the color conversion layer and the light-emitting diodes.

In an embodiment of the disclosure, the color conversion layer includes a phosphor layer or a quantum dot layer.

In an embodiment of the disclosure, the light-emitting diodes include a plurality of blue micro light-emitting diodes or a plurality of white micro light-emitting diodes.

In an embodiment of the disclosure, the driving circuit layer includes an active device array circuit or a redistribution circuit layer.

In an embodiment of the disclosure, the display structure layer further includes an adhesive layer disposed between the substrate and the light-emitting diodes. The planarization layer is located between the light-emitting diodes and the driving circuit layer.

In an embodiment of the disclosure, the light-emitting diodes include at least one red light-emitting diode, at least one green light-emitting diode, and at least one blue light-emitting diode.

In an embodiment of the disclosure, the driving circuit layer includes a redistribution circuit layer.

In an embodiment of the disclosure, the rear-view mirror displays a left image frame, a rear image frame, and a right image frame through a streaming media technology.

In an embodiment of the disclosure, the rear image frame is located between the left image frame and the right image frame, and an area of the rear image frame is larger than an area of the left image frame and an area of the right image frame.

In an embodiment of the disclosure, the area of the left image frame or the area of the right image frame occupies more than ¼ of a display frame of the rear-view mirror.

Based on the above description, the design of the rear-view mirror with the display function of the disclosure is to combine the rear-view mirror body with the display structure layer with use of the light-emitting diodes as light sources. Since the light-emitting diodes have a high resolution and do not need any backlight source due to its self-luminescence, compared with the existing digital LCD display installed on the interior rear-view mirror, the display structure layer provided in one or more embodiments of the disclosure is not limited to the backlight brightness adjustment design (the turn-on/off function), which improves driving safety of the driver.

To make the above description more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a schematic diagram of a rear-view mirror with a display function according to an embodiment of the disclosure.

FIG. 1B to 1D are schematic diagrams of image frames of the rear-view mirror depicted in FIG. 1A in different states.

FIG. 2 is a schematic diagram of a rear-view mirror with a display function according to another embodiment of the disclosure.

FIG. 3 is a schematic diagram of a rear-view mirror with a display function according to another embodiment of the disclosure.

FIG. 4 is a schematic diagram of a rear-view mirror with a display function according to another embodiment of the disclosure.

### DESCRIPTION OF THE EMBODIMENTS

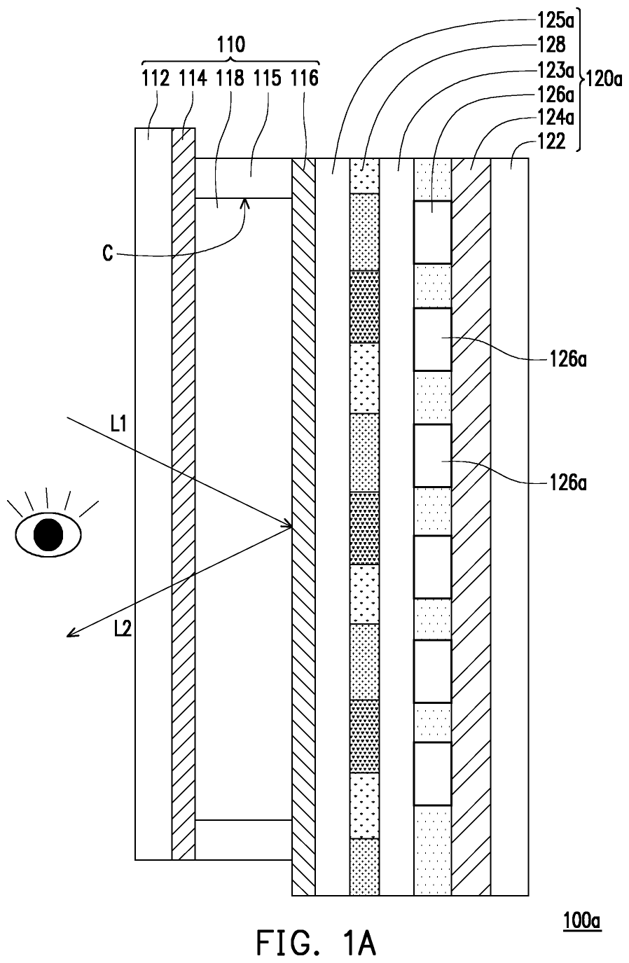

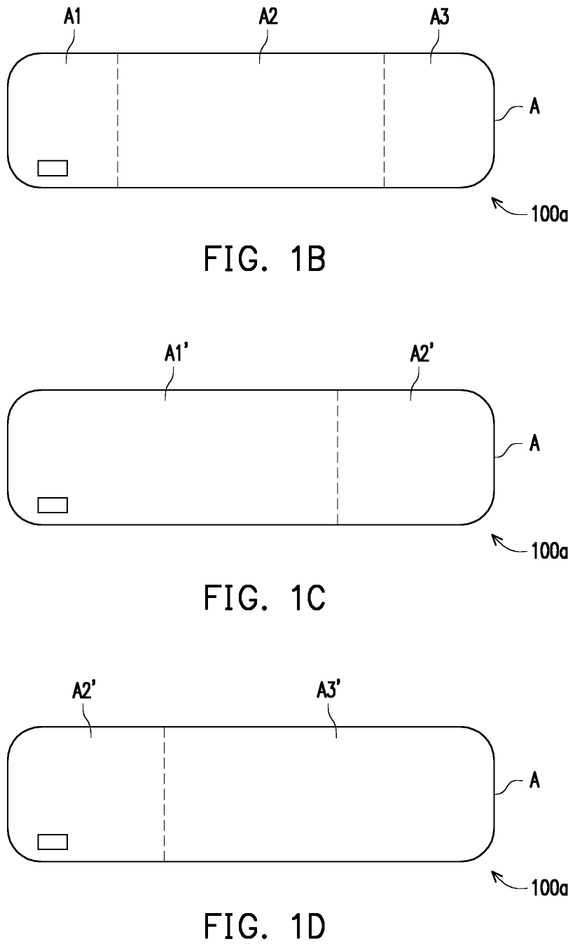

FIG. 1A is a schematic diagram of a rear-view mirror with a display function according to an embodiment of the disclosure. FIG. 1B to 1D are schematic diagrams of image frames of the rear-view mirror depicted in FIG. 1A in different states. As shown in FIG. 1A, in the embodiment, the rear-view mirror 100a with a display function includes a rear-view mirror body 110 and a display structure layer 120a. The display structure layer 120a is disposed on one side of the rear-view mirror body 110 and includes a plurality of light-emitting diodes 126a and a driving circuit layer 124a. The light-emitting diodes 126a are located between the rear-view mirror body 110 and the driving circuit layer 124a, and the light-emitting diodes 126a are electrically connected to the driving circuit layer 124a. The rear-view mirror 100a is, for example, a vehicle interior rear-view mirror.

In detail, in the embodiment, the rear-view mirror body 110 includes a substrate 112, a transparent electrode layer 114, a reflective electrode layer 116, a sealant 115 and an electrochromic material 118. The transparent electrode layer 114 is disposed on the substrate 112. The reflective electrode layer 116 is disposed on one side of the transparent electrode layer 114. The sealant 115 is disposed between the transparent electrode layer 114 and the reflective electrode layer 116, where the sealant 115, the transparent electrode layer 114, and the reflective electrode layer 116 define an accommodating space C. The electrochromic material 118 fills the accommodating space C. The substrate 112 is, for example, a glass substrate, a plastic substrate, or a laminated material substrate, but the disclosure is not limited thereto.

To be specific, the transparent electrode layer 114 and the reflective electrode layer 116 are used to drive the electrochromic material 118. When the electrochromic material 118 is enabled (for example, when there is a sufficient potential difference between the transparent electrode layer 114 and the reflective electrode layer 116), the electrochromic material 118 may have an electrochemical oxidation-reduction reaction to change its energy level, so as to present a diming state. At this time, when an external beam (i.e., an incident beam L1) sequentially penetrates through the substrate 112 and the transparent electrode layer 114 to reach the electrochromic material 118, the external beam may be absorbed by the electrochromic material 118, and the rear-view mirror 100a is switched to anti-glare mode. On the other hand, when the electrochromic material 118 is not enabled (for example, when there is no sufficient potential difference between the transparent electrode layer 114 and the reflective electrode layer 116), the electrochromic material 118 may present a light-transmitting state. At this time, the external beam (i.e., the incident beam L1) may sequentially penetrate through the substrate 112, the transparent electrode layer 114, and the electrochromic material 118 and is reflected by the reflective electrode layer 116 (i.e., to form a reflected beam L2), so that the rear-view mirror 100a is switched to a mirror mode. In other words, when the electrochromic material 118 is enabled, an ambient beam from the outside of the display structure layer 120a is dimmed by the electrochromic material 118; when the electrochromic material 118 is not enabled, the ambient beam from the outside of the display structure layer 120a penetrates through the electrochromic material 118 and is reflected by the reflective electrode layer 116. Preferably, in a normal state of an electrochromic actuation principle, a transmittance of a lens group in an initial state is about 70-80%, and in the enabled state, an external voltage is applied to the lens group to make the electrochromic material to produce a color change, and now the transmittance may be reduced to below 40%.

In brief, the incident beam L1 enters from the outside through a viewing surface of the substrate 112, and the incident beam L1 is reflected by the reflective electrode layer 116 so that the incident beam L1 exits from the viewing surface of the substrate 112. A reflectance of the rear-view mirror body 110 to the incident beam L1 is greater than 40%, and a transmittance of the rear-view mirror 100a to an image beam is greater than 15%. In an embodiment, a shape of the viewing surface is, for example, a circle, an ellipse, or a polygon. In another embodiment, the viewing surface may also be a full mirror surface. Moreover, in an embodiment, the rear-view mirror body may also include a housing, and the housing includes a side wall surrounding a periphery of the substrate, and the side wall has a front housing surface aligned with the viewing surface of the substrate. At this time, a surface shape of the viewing surface may be, for example, a planar surface or a curved surface. In addition, a material of the transparent electrode layer 114 provided in the embodiment is, for example, indium tin oxide, indium zinc oxide, aluminum tin oxide, aluminum zinc oxide, indium germanium zinc oxide, titanium oxide, or a composite material of at least two of the above materials. A material of the reflective electrode layer 116 is, for example, silver, copper, aluminum, titanium, nickel, chromium, molybdenum, or a composite material of at least two of the above materials.

With reference to FIG. 1A, the display structure layer 120a provided in the embodiment further includes a substrate 122 and a first planarization layer 123a. The driving circuit layer 124a is disposed on the substrate 122 and located between the light-emitting diodes 126a and the substrate 122. The first planarization layer 123a is disposed on the light-emitting diodes 126a, and the light-emitting diodes 126a are located between the first planarization layer 123a and the driving circuit layer 124a. In addition, the display structure layer 120a provided in the embodiment further includes a color conversion layer 128 and a second planarization layer 125a. The color conversion layer 128 is disposed on the first planarization layer 123a. The second planarization layer 125a is disposed on the color conversion layer 128 and located between the rear-view mirror body 110 and the color conversion layer 128. The driving circuit layer 124a is, for example, an active device array circuit or a redistribution circuit layer. The light-emitting diodes 126a are, for example, a plurality of blue micro light-emitting diodes. The color conversion layer 128 is, for example, a phosphor layer or a quantum dot layer.

Since the light-emitting diode 126a has advantages of high brightness, high resolution, and no backlight source (due to self-luminescence), compared with the existing digital LCD display installed on the interior rear-view mirror, the display structural layer 120a provided in the embodiment is not limited to the backlight brightness adjustment design (the turn-on/off function), which may improve the driving safety of the driver.

In terms of a manufacturing process, the substrate 122 is provided first. Then, fabrication of the driving circuit layer 124a, implantation of the light-emitting diodes 126a, formation of the first planarization layer 123a, screen-printing of the color conversion layer 128, formation of the second planarization layer 125a, and coating of the reflective electrode layer 116 are sequentially performed. Thereafter, the sealant 115, the transparent electrode layer 114 and the substrate 112 are assembled, and the electrochromic material 118 is injected after baking to complete the manufacture of the rear-view mirror 100a. In brief, the rear-view mirror 100a with the display function as provided in the embodiment is embodied as an integrated structure.

In terms of application, with reference to FIG. 1B, in the embodiment, the streaming media technology may be used to enable the rear-view mirror 100a to display a left image frame A1, a rear image frame A2, and a right image frame A3. Furthermore, the left image frame A1 displays a real-time image of a left side rear-view mirror outside the vehicle, and the right image frame A3 displays a real-time image of a right side rear-view mirror outside the vehicle. The rear image frame A2 is located between the left image frame A1 and the right image frame A3, and an area of the rear image frame A2 is larger than an area of the left image frame A1 and an area of the right image frame A3. In other words, the rear-view mirror 100a may display three streaming media real-time monitoring images at the same time, but the disclosure is not limited thereto. In another embodiment, the rear-view mirror 100a may also only display the rear image frame A2.

Then, with reference to FIG. 1C, when the vehicle turns left, an area of a left image frame A1′ may occupy more than ¼ of a display frame A of the rear-view mirror 100a. In other words, the left image frame A1′ may be enlarged to be more than ¼ of the overall display frame A, so that the driver may clearly see the real-time image of the left side rear-view mirror outside the vehicle. At this time, a rear image frame A2′ may be simultaneously displayed in the display frame A for the driver's reference.

Similarly, with reference to FIG. 1D, when the vehicle turns right, an area of a right image frame A3′ may occupy more than ¼ of the display frame A of the rear-view mirror 100a. In other words, the right image frame A3′ may be enlarged to be more than ¼ of the overall display frame A, so that the driver may clearly see the real-time image of the right side rear-view mirror outside the vehicle. At this time, the rear image frame A2′ may be simultaneously displayed in the display frame A for the driver's reference.

In brief, in the embodiment, rear-view mirror monitoring regions on the left side and the right side of the vehicle, a blind spot assist system, and a driving photography function, etc., may be combined to the interior rear-view mirror 100a by using streaming media, which may display/switch three real-time monitoring images, so that when the driver changes lanes or makes turns during driving, the left image frame A1 or the right image frame A3 may be enlarged to be more than ¼ of the display frame A according to requirements, which may avoid blind spots in the line of sight and improve safety of the driver.

To be more specific, in the embodiment, the streaming media is combined to the rear-view mirror 100 based on the advantages of high brightness, high resolution and no backlight source (due to self-luminescence) of the micro light-emitting diodes, and the rear-view mirror 100 may display/switch three real-time monitoring images to allow the driver to clearly see a state of the left side or the right side outside the vehicle when the driver needs to change lanes or make turns during driving, which improves the safety of the driver. Namely, in the embodiment, camera images (including a blind spot reminder) of the left and right sides outside the vehicle may be integrated to the interior rear-view mirror 100a to achieve a purpose of full-view monitoring. It should be noticed that reference numbers of the components and a part of contents of the above-mentioned embodiment are also used in the following embodiment, where the same reference numbers denote the same or like components, and descriptions of the same technical contents are omitted. The above-mentioned embodiment may be referred for descriptions of the omitted parts, and detailed descriptions thereof are not repeated in the following embodiment.

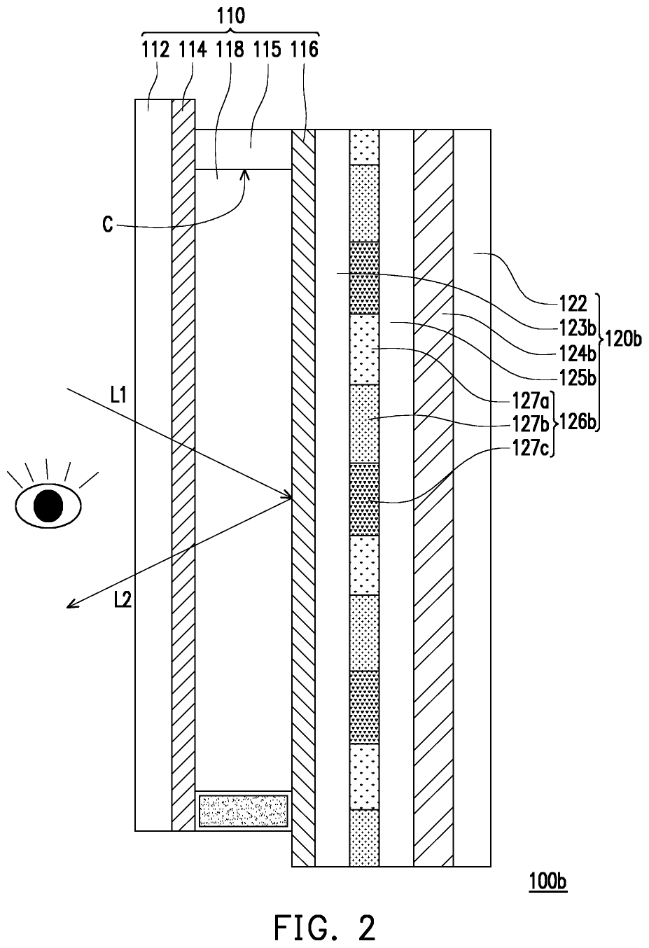

FIG. 2 is a schematic diagram of a rear-view mirror with a display function according to another embodiment of the disclosure. With reference to FIG. 1A and FIG. 2 at the same time, a rear-view mirror 100b provided in the embodiment is similar to the rear-view mirror 100a depicted in FIG. 1A, and a difference there between is that in the embodiment, the first planarization layer 123b is disposed on the light-emitting diodes 126b, and the light-emitting diodes 126b are located between the first planarization layer 123b and the driving circuit layer 124b. The first planarization layer 123b is located between the rear-view mirror body 110 and the light-emitting diodes 126b. In particular, the display structure layer 120b does not have the color conversion layer 128, and the second planarization layer 125b is located between the driving circuit layer 124b and the light-emitting diodes 126b. Here, the light-emitting diodes 126b, for example, include at least one red light-emitting diode 127a, at least one green light-emitting diode 127b, and at least one blue light-emitting diode 127c. The driving circuit layer 124b includes a redistribution circuit layer.

In terms of the manufacturing process, the substrate 122 is provided first. Then, fabrication of the driving circuit layer 124b, formation of the first planarization layer 123b, implantation of the light-emitting diodes 126b, formation of the second planarization layer 125a, and coating of the reflective electrode layer 116 are sequentially performed. Thereafter, the sealant 115, the transparent electrode layer 114 and the substrate 112 are assembled, and the electrochromic material 118 is injected after baking to complete the manufacture of the rear-view mirror 100b. In brief, the rear-view mirror 100b with the display function provided in the embodiment is embodied as an integrated structure.

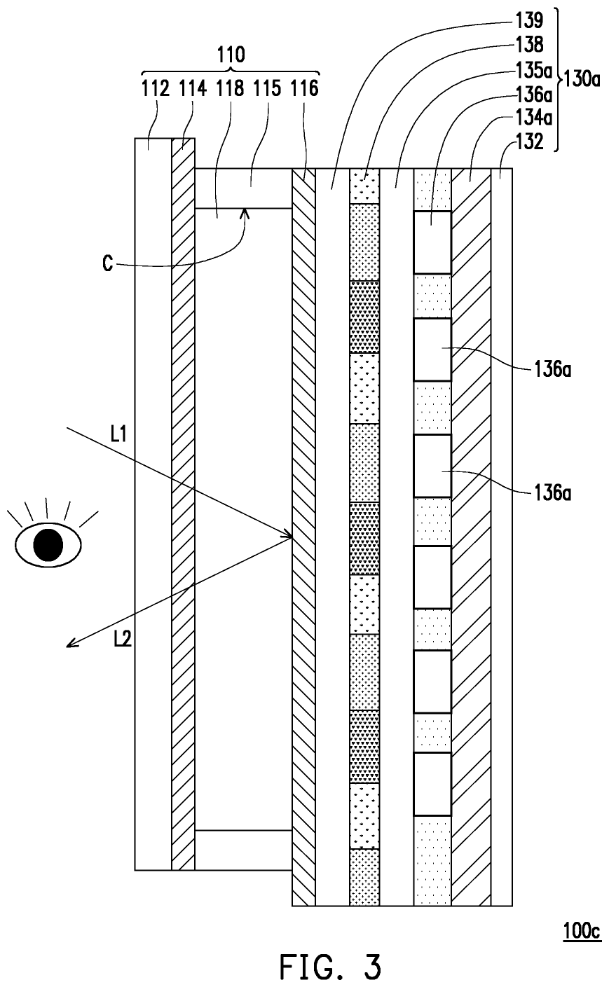

FIG. 3 is a schematic diagram of a rear-view mirror with a display function according to another embodiment of the disclosure. With reference to FIG. 1A and FIG. 3 at the same time, a rear-view mirror 100c provided in the embodiment is similar to the rear-view mirror 100a depicted in FIG. 1A, and a difference there between is that: in the embodiment, a display structure layer 130a is an external structure, which is hung on the rear-view mirror body 110.

In detail, in addition to a driving circuit layer 134a and light-emitting diodes 136a, the display structure layer 130a further includes a passivation layer 132, a substrate 139, and a planarization layer 135a. The driving circuit layer 134a is disposed on the passivation layer 132 and is located between the light-emitting diodes 136a and the passivation layer 132. The substrate 139 is disposed on the light-emitting diodes 136a and is located between the rear-view mirror body 110 and the passivation layer 132. The planarization layer 135a is disposed between the passivation layer 132 and the substrate 139. Furthermore, the display structure layer 130a provided in the embodiment further includes a color conversion layer 138, where the color conversion layer 138 is disposed on the planarization layer 135a and located between the substrate 139 and the planarization layer 135a. The planarization layer 135a is located between the color conversion layer 138 and the light-emitting diodes 136a. Here, the driving circuit layer 134a is, for example, an active device array circuit or a redistribution circuit layer. The light-emitting diodes 136a are, for example, a plurality of blue micro light-emitting diodes. The color conversion layer 138 is, for example, a quantum dot layer.

In terms of the manufacturing process, the substrate 139 is provided first. Then, fabrication of the color conversion layer 138 and the planarization layer 135a, implantation of the light-emitting diodes 136a, fabrication of the driving circuit layer 134a and coating of the passivation layer 132 are sequentially performed to complete the display structure layer 130a. Thereafter, the display structure layer 130a is turned over, and coating of the reflective electrode layer 116, assembling of the sealant 115, the transparent electrode layer 114 and the substrate 112 are sequentially performed, and then the electrochromic material 118 is injected after baking to complete the manufacture of the rear-view mirror 100c.

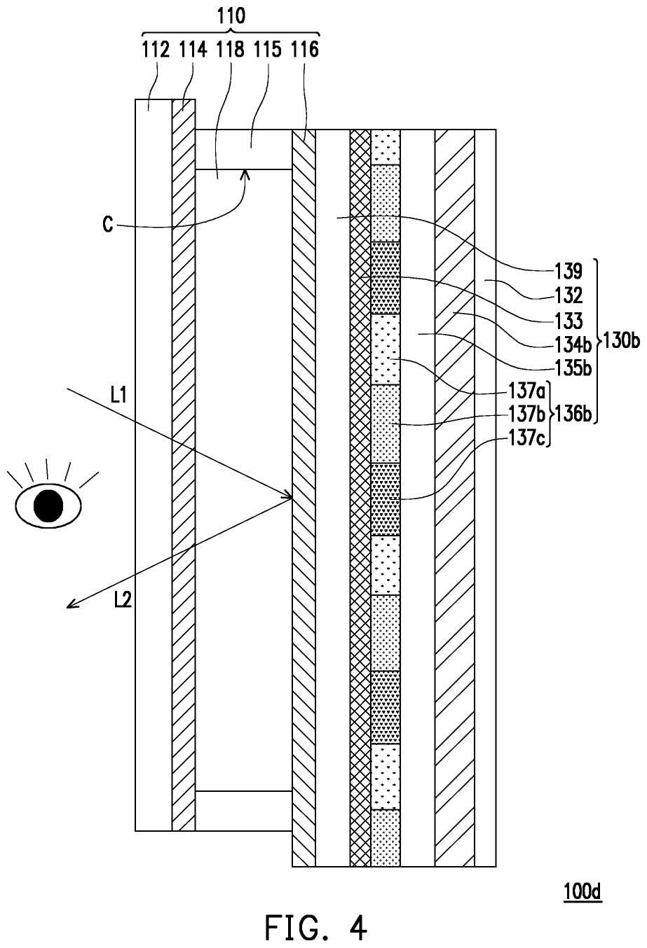

FIG. 4 is a schematic diagram of a rear-view mirror with a display function according to another embodiment of the disclosure. With reference to FIG. 3 and FIG. 4 at the same time, a rear-view mirror 100d provided in the embodiment is similar to the rear-view mirror 100c depicted in FIG. 3, and a difference there between is that in the embodiment, the display structure layer 130b does not have the color conversion layer 138, and the planarization layer 135b is located between the light-emitting diodes 136b and the driving circuit layer 134b. Furthermore, the display structure layer 130b provided in the embodiment further includes an adhesion layer 133 disposed between the substrate 139 and the light-emitting diodes 136b. Here, the driving circuit layer 134b includes a redistribution circuit layer. The light-emitting diodes 136b, for example, include at least one red light-emitting diode 137a, at least one green light-emitting diode 137b, and at least one blue light-emitting diode 137c.

In terms of the manufacturing process, the substrate 139 is provided first. Then, formation of the adhesive layer 133, implantation of the light-emitting diodes 136b, and the planarization layer 135b, fabrication of the driving circuit layer 134b and coating of the passivation layer 132 are sequentially performed to complete the display structure layer 130b. Thereafter, the display structure layer 130b is turned over, and coating of the reflective electrode layer 116, assembling of the sealant 115, the transparent electrode layer 114 and the substrate 112 are sequentially performed, and then the electrochromic material 118 is injected after baking to complete the manufacture of the rear-view mirror 100d.

To sum up, the design of the rear-view mirror with the display function of the disclosure is to combine the rear-view mirror body with the display structure layer with use of the light-emitting diodes as light sources. Since the light-emitting diodes have a high resolution and do not need any backlight source due to its self-luminescence, compared with the existing digital LCD display installed on the interior rear-view mirror, the display structure layer provided in one or more embodiments of the disclosure is not limited to the backlight brightness adjustment design (the turn-on/off function), which improves driving safety of the driver.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A rear-view mirror with a display function, comprising:
a rear-view mirror body; and
a display structure layer, disposed on one side of the rear-view mirror body and comprising a plurality of light-emitting diodes and a driving circuit layer, wherein the light-emitting diodes are located between the rear-view mirror body and the driving circuit layer, and the light-emitting diodes are electrically connected to the driving circuit layer.

2. The rear-view mirror according to claim 1, wherein the rear-view mirror body comprises:
a substrate;
a transparent electrode layer, disposed on the substrate;
a reflective electrode layer, disposed on one side of the transparent electrode layer;
a sealant, disposed between the transparent electrode layer and the reflective electrode layer, the sealant, the transparent electrode layer, and the reflective electrode layer defining an accommodating space; and
an electrochromic material, filling the accommodating space.

3. The rear-view mirror according to claim 2, wherein an incident beam enters from the outside through a viewing surface of the substrate, and the incident beam is reflected by the reflective electrode layer and exits from the viewing surface of the substrate, wherein a reflectivity of the rear-view mirror body to the incident beam is greater than 40%, and a transmittance of the rear-view mirror to an image beam is greater than 15%.

4. The rear-view mirror according to claim 1, wherein the display structure layer further comprises:
a substrate, wherein the driving circuit layer is disposed on the substrate and located between the light-emitting diodes and the substrate; and
a first planarization layer, disposed on the light-emitting diodes, the light-emitting diodes being located between the first planarization layer and the driving circuit layer.

5. The rear-view mirror according to claim 4, wherein the display structure layer further comprises:
a color conversion layer, disposed on the first planarization layer; and
a second planarization layer, disposed on the color conversion layer and located between the rear-view mirror body and the color conversion layer.

6. The rear-view mirror according to claim 5, wherein the color conversion layer comprises a phosphor layer or a quantum dot layer.

7. The rear-view mirror according to claim 6, wherein the light-emitting diodes comprise a plurality of blue micro light-emitting diodes or a plurality of white micro light-emitting diodes.

8. The rear-view mirror according to claim 5, wherein the driving circuit layer comprises an active device array circuit or a redistribution circuit layer.

9. The rear-view mirror according to claim 4, wherein the display structure layer further comprises:
a second planarization layer, located between the driving circuit layer and the light-emitting diodes.

10. The rear-view mirror according to claim 9, wherein the light-emitting diodes comprise at least one red light-emitting diode, at least one green light-emitting diode, and at least one blue light-emitting diode.

11. The rear-view mirror according to claim 9, wherein the driving circuit layer comprises a redistribution circuit layer.

12. The rear-view mirror according to claim 1, wherein the display structure layer further comprises:
a passivation layer, wherein the driving circuit layer is disposed on the passivation layer and located between the light-emitting diodes and the passivation layer;
a substrate, disposed on the light-emitting diodes and located between the rear-view mirror body and the passivation layer; and
a planarization layer, disposed between the passivation layer and the substrate.

13. The rear-view mirror according to claim 12, wherein the display structure layer further comprises:
a color conversion layer, disposed on the planarization layer and located between the substrate and the planarization layer, wherein the planarization layer is located between the color conversion layer and the light-emitting diodes.

14. The rear-view mirror according to claim 13, wherein the color conversion layer comprises a phosphor layer or a quantum dot layer.

15. The rear-view mirror according to claim 13, wherein the light-emitting diodes comprise a plurality of blue micro light-emitting diodes or a plurality of white micro light-emitting diodes.

16. The rear-view mirror according to claim 13, wherein the driving circuit layer comprises an active device array circuit or a redistribution circuit layer.

17. The rear-view mirror according to claim 12, wherein the display structure layer further comprises:
an adhesive layer, disposed between the substrate and the light-emitting diodes, wherein the planarization layer is located between the light-emitting diodes and the driving circuit layer.

18. The rear-view mirror according to claim 17, wherein the light-emitting diodes comprise at least one red light-emitting diode, at least one green light-emitting diode, and at least one blue light-emitting diode.

19. The rear-view mirror according to claim 17, wherein the driving circuit layer comprises a redistribution circuit layer.

20. The rear-view mirror according to claim 1, wherein the rear-view mirror displays a left image frame, a rear image frame, and a right image frame through a streaming media technology.

21. The rear-view mirror according to claim 20, wherein the rear image frame is located between the left image frame and the right image frame, and an area of the rear image frame is larger than an area of the left image frame and an area of the right image frame.

22. The rear-view mirror according to claim 20, wherein an area of the left image frame or an area of the right image frame occupies more than ¼ of a display frame of the rear-view mirror.
